(19) United States
(12) Patent Application Publication
(10) Pub. No.: US 2014/0150031 A1
(43) Pub. Date: May 29, 2014

(54) METHOD AND APPARATUS FOR ACCESSING MEDIA CONTENT

(71) Applicant: AT&T INTELLECTUAL PROPERTY I, LP, Atlanta, GA (US)

(72) Inventors: Shiv Kumar, Marlboro, NJ (US); Pradeep K. Khowash, Marlboro, NJ (US); Sanjay MacWan, Marlboro, NJ (US)

(73) Assignee: AT&T INTELLECTUAL PROPERTY I, LP, Atlanta, GA (US)

(21) Appl. No.: 13/687,310

(22) Filed: Nov. 28, 2012

(51) Int. Cl. H04N 21/414

(52) U.S. Cl. CPC H04N 21/41407
USPC 725/62

(57) ABSTRACT

A method that incorporates teachings of the subject disclosure may include, for example establishing, by a system comprising a processor, communication with a mobile wireless network to access a home media processor subscriber account via the mobile wireless network, receiving, by the system, media content from the mobile wireless network based on home media processor information from the home media processor subscriber account, and transmitting, by the system, to a display device a video stream generated from the media content. Other embodiments are disclosed.

### FIELD OF THE DISCLOSURE

The subject disclosure relates to a method and apparatus for accessing media content.

### BACKGROUND

Media content is typically experienced by consumers via devices such as computers, televisions, radios, and mobile electronics. Media content is delivered by service providers, who send the content, such as television, radio, and video programming, to consumers for enjoyment at their physical locations. Modern communications networks benefit from interconnectivity between consumers and various communication devices. As network capabilities expand, these interconnections provide new opportunities to enhance the ability for consumers to enjoy media content by experiencing a variety of content over multiple devices. Intelligent devices offer new means for the enjoyment of content in ways that anticipate consumer desires, including the personalization of media content presentation.

### BRIEF DESCRIPTION OF THE DRAWINGS

Reference will now be made to the accompanying drawings, which are not necessarily drawn to scale, and wherein:

FIGS. 1-2 depict illustrative embodiments of a system that can be utilized for providing access to media content via a wireless media processor in a networked media content system;

FIG. 3 depicts an illustrative embodiment of a method operating in portions of the system described in FIGS. 1-2 and 4-5;

FIGS. 4-5 depict illustrative embodiments of communication systems that provide media content;

FIG. 6 depicts an illustrative embodiment of a web portal for interacting with the communication systems of FIGS. 1-2 and 4-5;

FIG. 7 depicts an illustrative embodiment of a communication device; and

FIG. 8 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for remotely accessing a subscriber account associated with a home media processor device, receiving information associated with the home media processor device, using the received information for selecting media content over a mobile wireless network, and transmitting a video stream of the media content to a display device. Other embodiments are included in the subject disclosure.

One embodiment of the subject disclosure includes a memory storing computer instructions and a processor coupled to the memory. The processor can perform operations responsive to executing the computer instructions including detecting a mobile wireless network. The processor can also perform operations for transmitting a first request for remote access to a home media processor subscriber account via the mobile wireless network and, in turn, receiving authentication for the remote access to the home media processor subscriber account responsive to the first request. The processor can further perform operations for transmitting a second request for home media processor information from the mobile wireless network and, in turn, receiving the home media processor information from the mobile wireless network responsive to the second request. The processor can perform operations for selecting media content according to the home media processor information. The processor can further perform operations for receiving the media content that is selected from mobile wireless network. The processor can further perform operations for decoding the media content that is received to generate a video stream and, in turn, transmitting the video stream to a display device.

One embodiment of the subject disclosure includes a tangible computer-readable storage medium including computer instructions, which, responsive to being executed by a processor, can cause the processor to perform operations for transmitting a first request for remote access by a mobile media processor to a home media processor subscriber account via a mobile wireless network. The computer instructions can cause the processor to perform operations for receiving authentication for the remote access to the home media processor subscriber account responsive to the first request. The computer instructions can cause the processor to perform operations for transmitting a second request for home media processor information from the mobile wireless network. The computer instructions can cause the processor to perform operations for establishing wireless communications to a display device. The computer instructions can cause the processor to perform operations for selecting media content according to the home media processor information and receiving from the mobile wireless network the media content that is selected. The computer instructions can cause the processor to perform operations for transmitting a video stream of the media content for presentation at the display device.

One embodiment of the subject disclosure includes a method including establishing, by a system comprising a processor, communication with a mobile wireless network to access a home media processor subscriber account via the mobile wireless network. The method also includes receiving, by the system, media content from the mobile wireless network based on home media processor information from the home media processor subscriber account. The method further includes transmitting, by the system, to a display device a video stream generated from the media content.

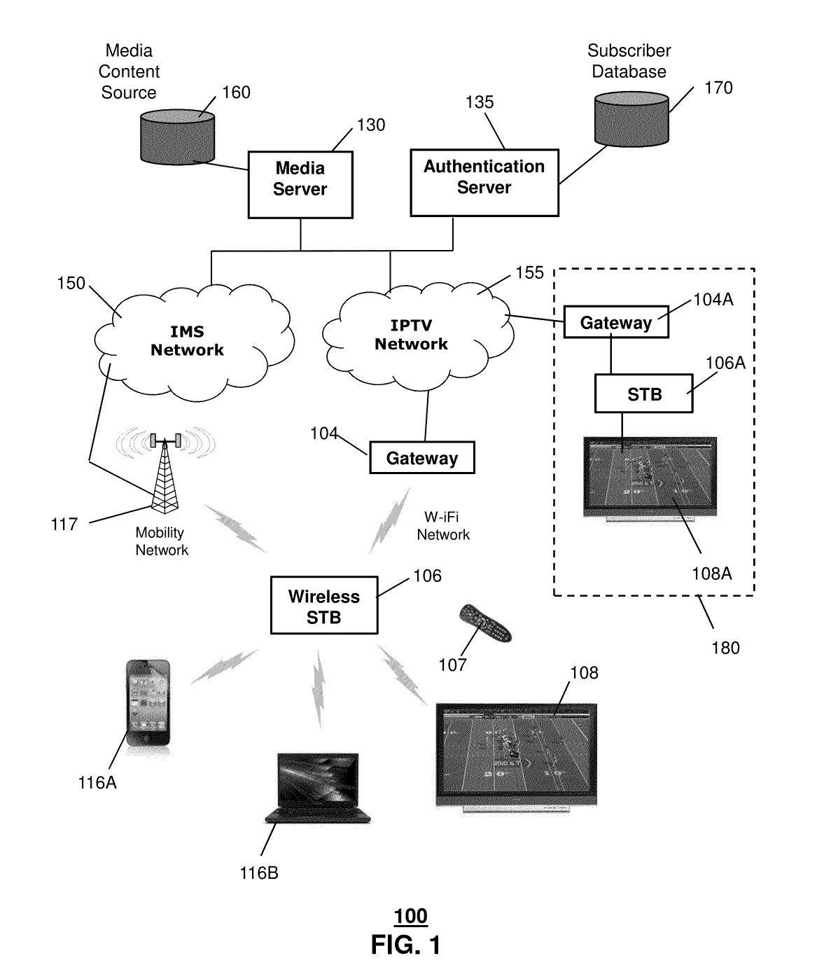

FIG. 1 depicts an illustrative embodiment of a system 100 that can be utilized for accessing media content via a wireless media processor in a networked media content system. In one embodiment, the system 100 can be a subscription content service. For example, the subscription content service can be part of a cable, satellite, or DSL based media content delivery system. The media content can be any type of viewable content, such as broadcast television, cable or premium television, video on demand, or pay-per-per view television. In one embodiment, the system 100 can include one or more media servers 130 that can receive media content from one or more media content sources 160. The media servers 130 can provide the media content to delivery networks 150 and 155. For example, a media server 130 can deliver media content services via an internet protocol television (IPTV) network 155 and/or via an internet protocol compatible, multimedia subsystem (IMS) network 150. The delivery networks 150 and 155 can, in turn, provide to media content to a consumers at a variety of media presentation devices 108, 108A, 116A, and 116B. In other embodiments, the media server 130 can deliver media content by a private communication network or by a public communication network, such as the World Wide Web. In other embodiments, the media server 130 can deliver media content using any type of transport media, such as a satellite link, a cable line, and/or a fiber optic network.

The system 100 can further include authentication functions to insure that media content is distributed only to verified subscribers to the system according to the service plan levels of those subscribers. For example, the system 100 can verify that a home-based media processor device 106A located at, for example, a residence 180 of a subscriber to a media service provider. For example, the home-based media processor device 106A can be a set-top box. In one embodiment, the home-based media processor device 106A can be properly identified and validated for receiving media content over the system 100. For example, an authentication server 135 can be used to verify the subscription status of the home-based media processor device 106A. Device identifying information, such as MAC address, IP address, and/or SIM card information, can be transmitted to the authentication server 135. The authentication server 135 can use this identifying information from the home-based media processor device 106A to inquire at a subscriber database 170 for service plan information for a subscriber who is associated with the device 106A. The subscriber database 170 can provide subscription status and service plan information to allow the authentication server 135 to enable delivery of purchased media content to the home-based media processor device 106A. In one or more embodiments, the media content can be selected based on a number of techniques and criteria, such as based on user input, user preferences, user profiles, monitored user viewing history, and so forth.

Media content can be received at the home-based media processor device 106A by way of a gateway device 104A. In one embodiment, the gateway device 104A can function as an interface between the IPTV network 155 and the media processor device 106A. In one embodiment, the gateway device 104A can provide internet working functions, such as protocol translation, impedance matching, data rate conversion, and/or fault isolation necessary for exchanging data between the IPTV network 155 and the home-based media processor device 106A.

The home-based media processor device 106A and a display device 108A can be integrated into a single device, such as a television with a built in set-top box or a mobile device with integrated media processor functionality. The home-based media processor device 106A can receive the media content as encoded data packet streams and can decode the received data streams into decoded stream that can be delivered to the display device 108A for presentation. In other embodiments, the home-based media processor device 106A can further perform functions of providing an electronic programming guide for selection of programming from the media server 130, authentication of the media processor device 106A for reception of media content, storage and updating of user preferences, and/or parental control of media content. In one embodiment, the home-based media processor device can be configured with custom user settings to control operations of the program guide, such as channel display order, favorites, channel hiding, and operations of a digital video recorder unit. In one embodiment, one or more aspects of customer user settings and/or programming stored on the digital video recorder unit can be replicated at the IPTV network 155, at the subscriber database 170, or at a cloud-based storage location.

In one embodiment, a wireless media processor device 106 can be configured to receive media content from the system 100. In one embodiment, the wireless media processor device 106 can be a wireless set-top box. For example, the wireless media processor device 106 can be a portable device that can be easily moved within the user's premises or that can be carried to any location. In one embodiment, the wireless media processor device 106 can include one or more wireless transceivers for supporting one or more wireless communication links. For example, the wireless media processor device 106 can support wireless links to upstream networks 150 and 155 for accessing media content. In another example, the media processor device 106 can support wireless links to one or more downstream devices 116A and 116B to supply decoded media content for presentation to viewers.

In one embodiment, the wireless media processor device 106 can support a wireless communication link with a mobility network 117, such as a cellular network, a long term evolution (LTE) network, or a fourth generation (4G) wireless network. For example, the wireless media processor device 106 can include a cellular transceiver capable of bi-direction communications with the IMS network 150. In one embodiment, the wireless media processor device 106 can receive media content from the media server 130 by way of the IMS network by way of a wireless communication link to the mobility network 117. In one embodiment, the wireless media processor device 106 can detect the presence of a mobile wireless network, such as the mobility network 117. If a mobility network 117 is detected, then the wireless media processor 106 can attempt to establish communications with the network. In one embodiment, the IMS network 150 can verify that the wireless media processor device 106 is a subscriber to the IMS network 150. Alternatively, the IMS network 150 can verify a roaming relationship whereby the wireless media processor device 106 is permitted to communicate over the IMS network as a visitor to the network while incurring roaming charges. The ability to connect to a wireless mobility network 117 allows the wireless media processor device 106 to be operated at any location covered by a wireless network to provide media content to devices 108, 116A, and 116B using a subscriber's media account.

In one embodiment, the wireless media processor device 106 can establish a wireless communication link to a gateway device 104 to access media content from a media server 130 via the IPTV network 155. For example, the wireless media processor device 106 can connect a Wi-Fi link to the gateway device 104. In one embodiment, the wireless media processor device 106 can detect the presence of a Wi-Fi network emanating from the gateway device 104 or from a local router device connected to the gateway device 104. If a Wi-Fi network is detected, then the wireless media processor 106 can attempt to establish communications with the network. A local Wi-Fi network can require authentication of the wireless media processor device 106. In one embodiment, the wireless media processor device 106 can detect capability to access media content through the Wi-Fi connection at the IPTV network 155 and can initiate communication though IPTV network 155 rather than through the IMS network 150 to save cellular bandwidth usage and/or prevent charges for cellular communication.

In one embodiment, after the wireless media processor device 106 has established wireless communications with either the IMS network 150 or the IPTV network 155, then the device 106 can request remote access to the subscriber account associated with the home media processor device 106A. This request can be routed to an authentication server 135 that can verify the wireless media processor device 106 against a subscriber database 170. In one embodiment, a user of the wireless media processor device 106 can be required to enter personal identifying information, such as a user name and/or password. In another embodiment, the wireless media processor device 106 is identified based on device-specific information, such as a MAC address or a serial number, or based on a subscriber identity module (SIM) card in the device 106. Once verified, the wireless media processor device 106 can request information associated with the home media processor device 106A. In one embodiment, the wireless media processor device 106 can request information on the user configuration at the home media processor device 106A. For example, electronic programming guide setup and display features, parental control features and passwords, and home network configuration information can be accessed. The service provider can provide this information by sending one or more files to the wireless media processor device 106. This information can be periodically reported from the home media processor device 106A to the service provider for storage at the subscribe database 170. The wireless media processor device 106 can use the information to reproduce the home use experience at the wireless device 106. For example, the look and feel of the electronic programming guide can be recreated at remote locations.

In another embodiment, the wireless media processor device 106 can receive information on media content that is stored at a digital video recorder at the home media processor device 106A. For example, the service provider can send a file to the wireless media processor device 106 listing information about recorded content at the subscriber's home. In another embodiment, the wireless media processor device 106 can request the stored content for viewing at a remote location. In one embodiment, the service provider can determine the identity of the stored media content at the home media processor device 106A and can obtain the same media programming from a media content source 160 for delivery to the wireless media processor device 106. In another embodiment, the home media processor device 106A can maintain recorded media content at a cloud location through the IPTV network 155. The media server 130 can access the stored content from the cloud storage and provide this content to the wireless media processor device 106 via either the IPTV network 155 or the IMS network 150. The wireless media processor device 106 can access thereby access the same resources available to the subscriber at the subscriber's residence 180.

In one embodiment, the wireless media processor device 106 can receive user command inputs from a remote controller 107. The command inputs can control functions for presentation of the media content at any of several media display devices 116A, 116B, and 108. For example, the remote controller 107 can control starting a media presentation by selecting the media content from an electronic programming guide at the wireless media processor device 106 or by enabling a PLAY function from a digital video recording (DVR) module at the wireless media processor device 106. The wireless media processor device 106 can receive these remote commands over a wireless interface and can convert these commands into operational actions. In other embodiments, the wireless media processor device 106 can similarly process and execution operational commands for stopping, pausing, skipping, fast forwarding, and/or repeating portions of the media content. In another embodiment, the wireless media control processor 106 can perform commands to adjust a presentation volume, to mute or unmute the presentation speakers, and/or to select a picture characteristic such screen resolution or aspect ratio.

In one embodiment, the wireless media processor device 106 can establish wireless communications with one or more presentation devices 108, 116A, and 116B. For example, the wireless media processor device 106 can communicate to a media device 116A using a wireless access protocol such as Wi-Fi, Bluetooth, Zigbee, or other present or next generation local or personal area wireless network technologies. The media presentation device can take any of several forms, including mobile communication device 116A, a personal computing device 116B, or a television device 108. In one embodiment, the wireless media processor device 106 can transmit an electronic programming guide for display a media presentation device 116A. A remote control device 107 can be used to select a media program from the electronic programming guide. The wireless media processor device 106 can request the selected program from the media server 130. The media server 130 can authenticate the wireless media processor device's permission to receive the program, using for example the authentication server 135. The media sever 130 can provide the selected media program to the wireless media processor device 106 via either the IMS network 150 or the IPTV network. In one embodiment, the wireless media processor device 106 can decode a media program stream and transmit the decoded stream to one or more of the presentation devices 108, 116A, and 116B.

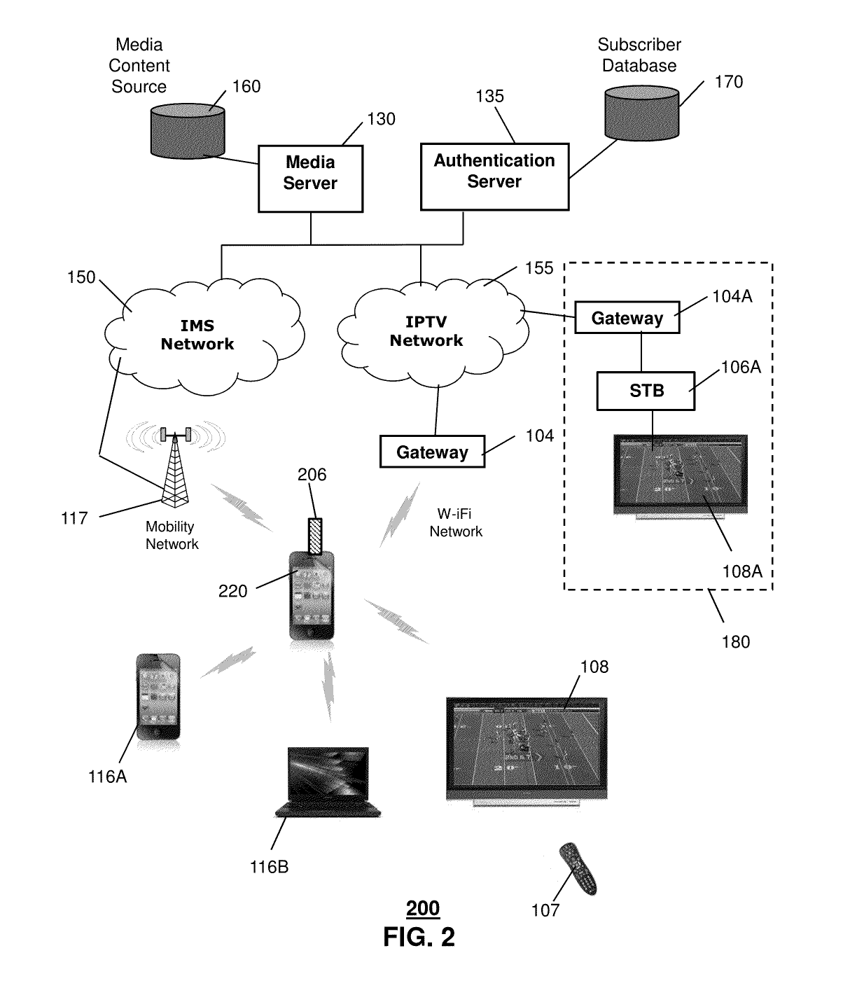

FIG. 2 depicts another illustrative embodiment of a system 200 that can be utilized for accessing media content via a wireless media processor in a networked media content system. In this embodiment, a wireless media processor device 206 can be incorporated into a mobile communication device 220, such as a smart phone device 220. In one embodiment, the wireless media processor device 206 can be a plug-in attachment to the mobile communication device 220. In another embodiment, the wireless media processor device 206 can be integrated into the mobile communication device 220. In one embodiment, the wireless media processor device 206 can use cellular and/or Wi-Fi transceiver capability of the mobile communication device 220 to access the IMS network 150 and/or the IPTV network 155. In another embodiment, the wireless media processor device 206 can include its own wireless communication transceiver to communicate with the IMS network 150 and/or the IPTV network 155. In one embodiment, an electronic programming guide can be displayed at the mobile communication device 220 for selecting programming content from the service provider. The wireless media processor device 206 can be operated as an application of the mobile communication device 220 or can be a stand-alone device that merely accesses the wireless transceiver capabilities of the mobile device 220. In one embodiment, media programming that is received and decoded at the wireless media processor device 206 can be viewed at mobile communication device 220. In another embodiment, the media processor device 206 can communicate with one or more presentation devices 108, 116A, and 116B. In one embodiment, the wireless media processor device 206 can use wireless capability of the mobile communication device 220 to communicate with the presentation devices 108, 116A, and 116B. In another embodiment, the wireless media processor device 206 can provide its own wireless capability. The media sever 130 can provide a selected media program to the wireless media processor device 206 via either the IMS network 150 or the IPTV network. In one embodiment, the wireless media processor device 206 can decode a media program stream and transmit the decoded stream to one or more of the presentation devices 108, 116A, and 116B.

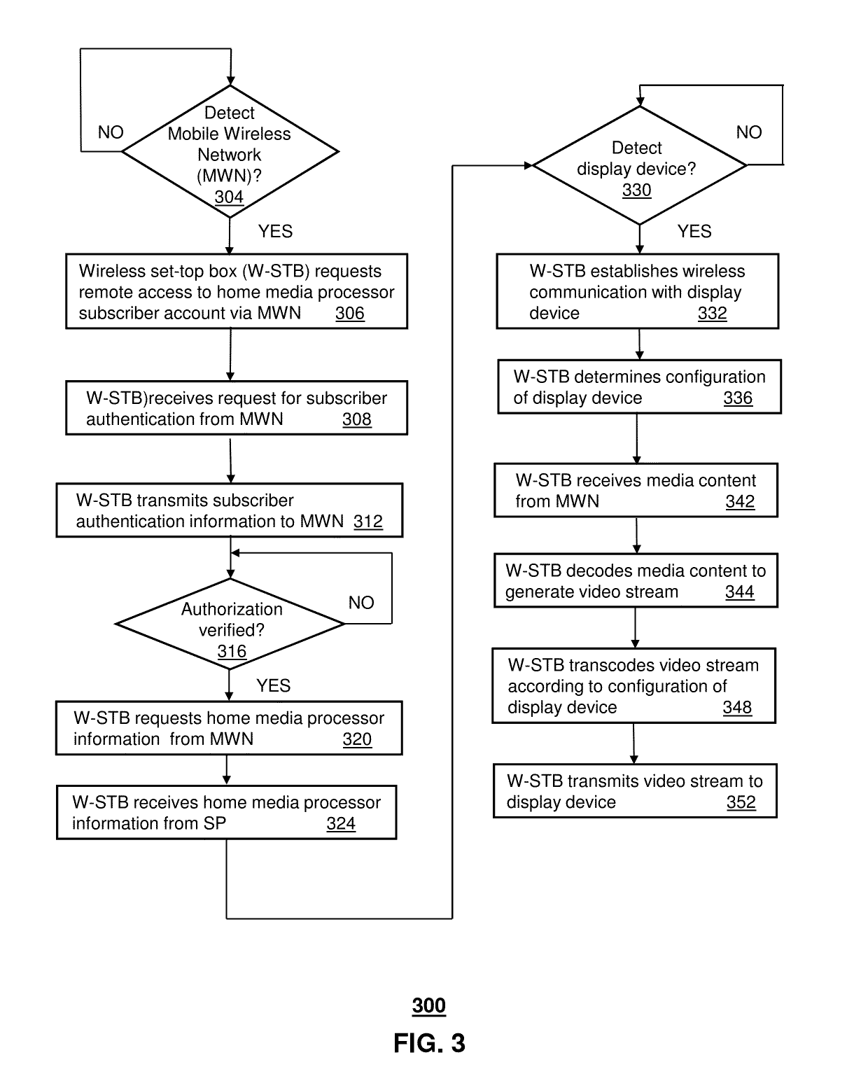

FIG. 3 depicts an illustrative embodiment of a method operating in portions of the systems and devices described in FIGS. 1-5. Method 300 can begin with step 304, in which a wireless media processor device 106 can detect a mobile wireless network 117. In one embodiment, the wireless media processor device 106 can include a transceiver capable of wireless communication with a mobility network 117, such as a cellular network, a long term evolution (LTE) network, or a fourth generation (4G) wireless network. In another embodiment, the wireless media processor device 106 can include a transceiver capable of wireless communication with a gateway device 104 that supports wireless communication. In one embodiment, the wireless media processor device 106 can communicate with an IMS network 150 and/or an IPTV network 155 via a wireless interface.

If the wireless media processor device 106 detects a mobile wireless network at step 304, then, in step 306, the wireless media processor device 106 can request remote access to a subscriber account of a home media processor device 106. In step 308, the wireless media processor device 106 can receive a request from the IMS network 150 or the IPTV network 155, by way of the mobile wireless network 117. In one embodiment, the request for access to the subscriber account information is transmitted to service provider network, such as to a media server 130. This request can be routed to an authentication server 135 that can verify the wireless media processor device 106 against a subscriber database 170. In response, the wireless media processor device 106 can receive a request for subscriber authentication information from the mobile wireless network 117 in step 308. In one embodiment, the IMS network 150 or the IPTV network 155 can verify that the wireless media processor device 106 is a subscriber to the IMS network 150. In another embodiment, the IMS network 150 can verify a roaming relationship whereby the wireless media processor device 106 is permitted to communicate over the IMS network as a visitor to the network while incurring roaming charges. In step 312, the wireless media processor device 106 can transmit subscriber authentication information to the mobile wireless network. In one embodiment, a user of the wireless media processor device 106 can be required to enter personal identifying information, such as a user name and/or password. In another embodiment, the wireless media processor device 106 is identified based on device-specific information, such as a MAC address or a serial number, or based on a subscriber identity module (SIM) card in the device 106. In step 316, the authentication information can be verified by the service provider, such as by the authentication server 135.

If the authorization is verified, then the wireless media processor device 106 can request home media processor information from the mobile wireless network in step 320. In one embodiment, the wireless media processor device 106 can request information regarding the user configuration at the home media processor device 106A regarding media content stored at the device 106A. In step 324, the wireless media processor device 106 cab receive the information associated with the home media processor device 106A. For example, an electronic programming guide setup and display features, parental control features and passwords, and home network configuration information can be provided. In another embodiment, the wireless media processor device 106 can receive information on media content that is stored at a digital video recorder at the home media processor device 106A.

In step 330, the wireless media processor device 106 can attempt to detect a media display device 108. In one embodiment, the media display device 108 can include wireless communication capability. The wireless media processor device 106 can detect the presence of a wireless communication signal and determine that the media display device 108 is accessible for communication based on the presence of the signal. If the media display device 108, in step 330, then, in step 332, the wireless media processor device 106 can establish wireless communications the presentation device 108. For example, the wireless media processor device 106 can communicate with a media display device 108 using a wireless access protocol such as Wi-Fi, Bluetooth, Zigbee, or other present or next generation local or personal area wireless network technologies. The media presentation device 108 can take any of several forms, including mobile communication device 116A, a personal computing device 116B, or a television device 108.

In step 336, the wireless media processor device 106 can determine one or more configurations of the media display device 108. In one embodiment, media display device 108 can include several configurations for its display, such as dots-per-inch (DPI), aspect ratio, high-definition capability, and refresh speed. In step 342, the wireless media processor device 106 can receive media content from the mobile wireless network 117. In one embodiment, the wireless media processor device 106 can transmit an electronic programming guide for display a media presentation device 108, and a remote control device 107 can be used to select a media program from the electronic programming guide. In one embodiment, the wireless media processor device 106 can request the selected program from the media server 130 by way of the mobile wireless network 117. In step 344, the wireless media processor device 106 can decode a media program video stream and, in step 344. In step 348, the wireless media processor device 106 can transcode the received media program video stream according to the configuration of the media display device 108. For example, the wireless media processor device 106 can reduce the resolution of the video stream to fit a display having lower resolution. In another embodiment, the wireless media processor device 106 can transcode the media content data to account of limitations in the wireless interface between the wireless media processor device 106 and the media display device 108. In step 352, the wireless media processor device 106 can transmit the decoded stream to the media display device 108.

Upon reviewing the aforementioned embodiments, it would be evident to an artisan with ordinary skill in the art that said embodiments can be modified, reduced, or enhanced without departing from the scope and spirit of the claims described below. For example, in one embodiment, the wireless media processor device 106 can connect to a media display device 108 via a high definition multimedia interface (HDMI) or a digital visual interface (DVI). In one embodiment, the wireless media processor device 106 can provide media content to a media display device 108 or to an integrated mobile communication device 206 in an aircraft during a low-altitude flight or in a moving automobile.

In another embodiment, the wireless media processor device 106 can automatically detect a wireless interface to a gateway device 104 connected to an IPTV network 155 even if the wireless media processor device 106 is already connected to the IMS network 150 via an mobile wireless network 117. The wireless media processor device 106 can further automatically connect to the IPTV network 155 to save cellular bandwidth and possible data charges that would otherwise be used when receiving media content through the IMS network 150.

In another embodiment, the wireless media processor device 106 can be authenticated by the authentication server using a digital certificate that is issued from a certificate issuing authority. In another embodiment, the home media processor device 106A can receive media content from a first service provider while the wireless media processor device 106 receives content from a second service provider. For example, if the wireless media processor device 106 is at a location where the first service provider does not support wireless service, then the wireless media processor device 106 can receive from the second service provider. However, the wireless media processor device 106 can receive still receiver home media processor device information as routed by the first provider through the second provider network. This embodiment would entail a cooperating agreement between the service providers to share information.

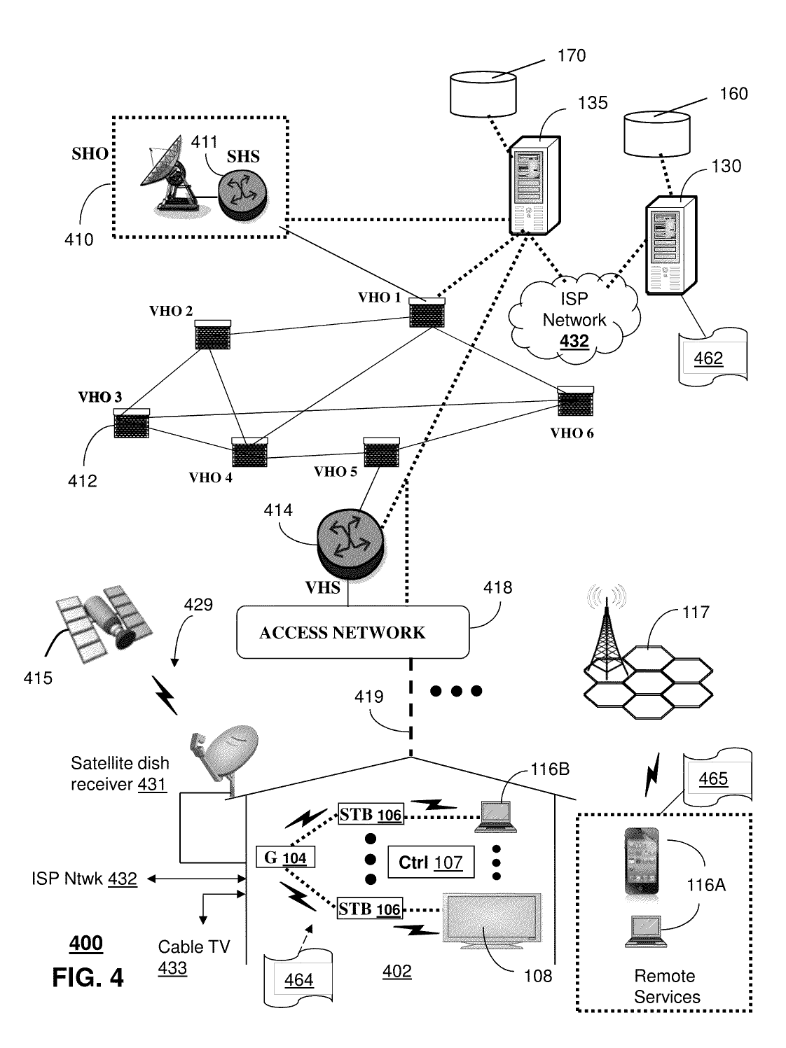

FIG. 4 depicts an illustrative embodiment of a first communication system 400 for delivering media content. The communication system 400 can represent an Internet Protocol Television (IPTV) media system that can be used for delivering media content in the systems 100 of FIG. 1. The communication system 400 can be utilized to provide media content to a wireless media processor device 106 for presentation by a media display device 108 by means of media server 130. In one embodiment, the system 100 can be a subscription content service. The media content can be any type of viewable content, such as broadcast television, cable or premium television, video on demand, or pay-per-per view television. In one embodiment, the system 100 can include one or more media servers 130 that can receive media content from one or more media content sources 160. The media servers 130 can deliver media content through the IPTV network 400 to the wireless media processor device 106. The wireless media processor device 106 can provide the delivered media content to one or more media presentation devices 108 and 116B.

The IPTV media system 400 can include a super head-end office (SHO) 410 with at least one super headend office server (SHS) 411 which receives media content from satellite and/or terrestrial communication systems. In the present context, media content can represent, for example, audio content, moving image content such as 2D or 3D videos, video games, virtual reality content, still image content, and combinations thereof. The SHS server 411 can forward packets associated with the media content to one or more video head-end servers (VHS) 414 via a network of video head-end offices (VHO) 412 according to a multicast communication protocol.

The VHS 414 can distribute multimedia broadcast content via an access network 416 to commercial and/or residential buildings 402 housing a gateway 404 (such as a residential or commercial gateway). The access network 416 can represent a group of digital subscriber line access multiplexers (DSLAMs) located in a central office or a service area interface that provide broadband services over fiber optical links or copper twisted pairs 419 to buildings 402. The gateway 104 can use communication technology to distribute broadcast signals to media processors 106 such as Set-Top Boxes (STBs) which in turn present broadcast channels to media devices 406 such as computers or television sets managed in some instances by a media controller 107 (such as an infrared or RF remote controller).

The gateway 104, the media processors 106, and media devices 108 can utilize tethered communication technologies (such as coaxial, powerline or phone line wiring) or can operate over a wireless access protocol such as Wireless Fidelity (Wi-Fi), Bluetooth, Zigbee, or other present or next generation local or personal area wireless network technologies. By way of these interfaces, unicast communications can also be invoked between the media processors 106 and subsystems of the IPTV media system for services such as video-on-demand (VoD), browsing an electronic programming guide (EPG), or other infrastructure services.

A satellite broadcast television system 429 can be used in the media system of FIG. 4. The satellite broadcast television system can be overlaid, operably coupled with, or replace the IPTV system as another representative embodiment of communication system 400. In this embodiment, signals transmitted by a satellite 415 that include media content can be received by a satellite dish receiver 431 coupled to the building 402. Modulated signals received by the satellite dish receiver 431 can be transferred to the media processors 106 for demodulating, decoding, encoding, and/or distributing broadcast channels to the media display devices 108. The media processors 106 can be equipped with a broadband port to an Internet Service Provider (ISP) network 432 to enable interactive services such as VoD and EPG as described above.

In yet another embodiment, an analog or digital cable broadcast distribution system such as cable TV system 433 can be overlaid, operably coupled with, or replace the IPTV system and/or the satellite TV system as another representative embodiment of communication system 400. In this embodiment, the cable TV system 433 can also provide Internet, telephony, and interactive media services. The subject disclosure can apply to other present or next generation over-the-air and/or landline media content services system.

Some of the network elements of the IPTV media system can be coupled to one or more computing devices 130, a portion of which can operate as a web server for providing web portal services over the ISP network 432 to wireline media devices 406 or wireless communication devices 416.

Communication system 400 can also provide for all or a portion of the computing devices 130 to function as a media server 130. The media server 130 can use computing and communication technology to perform function 462, which can include among other things, providing media content to one or more media processor devices 106. The media processors 106 and mobile communication devices 116A and 116B can be provisioned with software functions 464 and 465, respectively, to utilize the services of media server 130.

Multiple forms of media services can be offered to media devices over landline technologies such as those described above. Additionally, media services can be offered to media devices by way of a wireless access base station 117 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

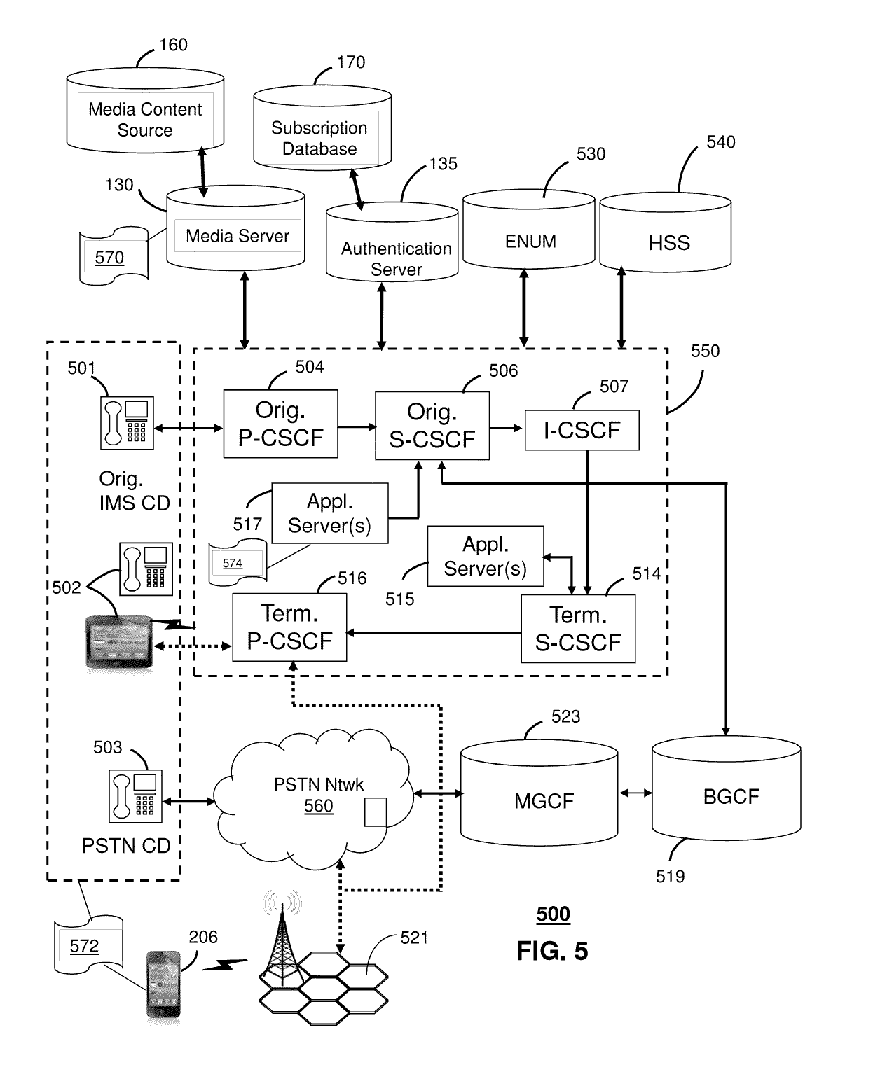

FIG. 5 depicts an illustrative embodiment of a communication system 500 employing IP Multimedia Subsystem (IMS) network architecture to facilitate the combined services of circuit-switched and packet-switched systems. The communication system 500 can represent an IMS media system that can be used for delivering media content and telephony services in the system 100 of FIG. 1. Communication system 500 can also be overlaid or operably coupled with communication system 400 as another representative embodiment of communication system 400. The communication system 500 can be utilized to provide media content by a media server 130 and bi-directional telecommunication to communication devices (CD) 501-5. The communication system 500 can also be utilized to provide media content by a media server 130 to a wireless media processor device 106.

Communication system 500 can comprise a Home Subscriber Server (HSS) 540, a tElephone NUmber Mapping (ENUM) server 530, and other network elements of an IMS network 550. The IMS network 550 can establish communications between IMS-compliant communication devices (CDs) 501, 502, Public Switched Telephone Network (PSTN) CDs 503, 505, and combinations thereof by way of a Media Gateway Control Function (MGCF) 523 coupled to a PSTN network 560. The MGCF 523 need not be used when a communication session involves IMS CD to IMS CD communications. A communication session involving at least one PSTN CD may utilize the MGCF 523.

IMS CDs 501, 502 can register with the IMS network 550 by contacting a Proxy Call Session Control Function (P-CSCF) which communicates with an interrogating CSCF (I-CSCF), which in turn, communicates with a Serving CSCF (S-CSCF) to register the CDs with the HSS 540. To initiate a communication session between CDs, an originating IMS CD 501 can submit a Session Initiation Protocol (SIP INVITE) message to an originating P-CSCF 504 which communicates with a corresponding originating S-CSCF 506. The originating S-CSCF 506 can submit the SIP INVITE message to one or more application servers (ASs) 517 that can provide a variety of services to IMS subscribers.

For example, the application servers 517 can be used to perform originating call feature treatment functions on the calling party number received by the originating S-CSCF 506 in the SIP INVITE message. Originating treatment functions can include determining whether the calling party number has international calling services, call ID blocking, calling name blocking, 5-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 506 can submit queries to the ENUM system 530 to translate an E.164 telephone number in the SIP INVITE message to a SIP Uniform Resource Identifier (URI) if the terminating communication device is IMS-compliant. The SIP URI can be used by an Interrogating CSCF (I-CSCF) 507 to submit a query to the HSS 540 to identify a terminating S-CSCF 514 associated with a terminating IMS CD such as reference 502. Once identified, the I-CSCF 507 can submit the SIP INVITE message to the terminating S-CSCF 514. The terminating S-CSCF 514 can then identify a terminating P-CSCF 516 associated with the terminating CD 502. The P-CSCF 516 may then signal the CD 502 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

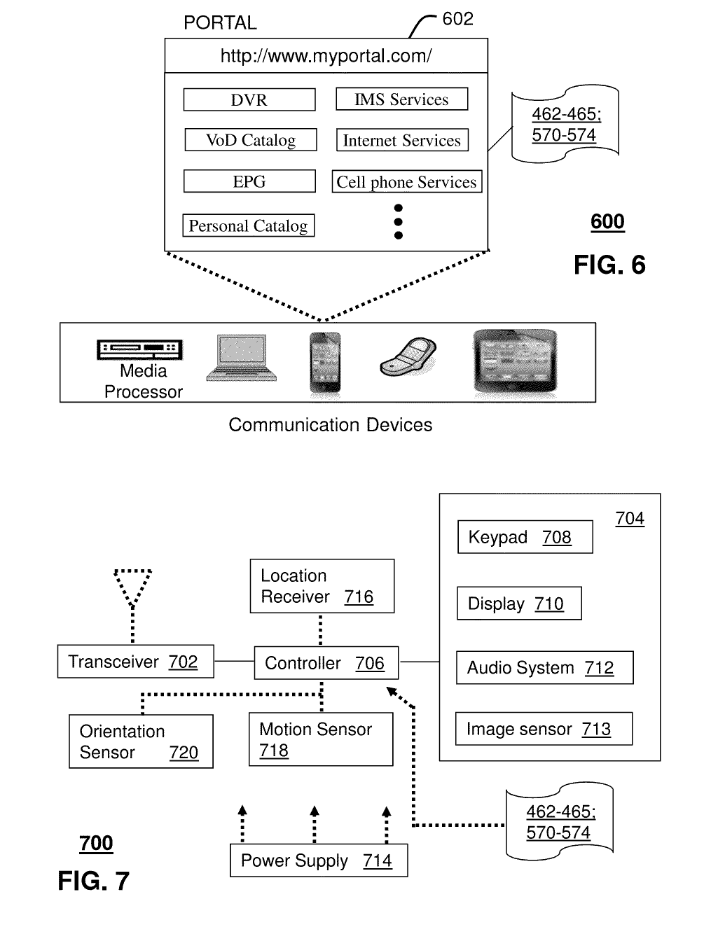

In some instances the aforementioned communication process is symmetrical. Accordingly, the terms “originating” and “terminating” in FIG. 5 may be interchangeable. It is further noted that communication system 500 can be adapted to support video conferencing. In addition, communication system 500 can be adapted to provide the IMS CDs 501, 502 with the multimedia and Internet services of communication system 600 of FIG. 6.

If the terminating communication device is instead a PSTN CD such as CD 503 or CD 505 (in instances where the cellular phone only supports circuit-switched voice communications), the ENUM system 530 can respond with an unsuccessful address resolution which can cause the originating S-CSCF 506 to forward the call to the MGCF 523 via a Breakout Gateway Control Function (BGCF) 519. The MGCF 523 can then initiate the call to the terminating PSTN CD over the PSTN network 560 to enable the calling and called parties to engage in voice and/or data communications.

It is further appreciated that the CDs of FIG. 5 can operate as wireline or wireless devices. For example, the CDs of FIG. 5 can be communicatively coupled to a cellular base station 521, a femtocell, a Wi-Fi router, a Digital Enhanced Cordless Telecommunications (DECT) base unit, or another suitable wireless access unit to establish communications with the IMS network 550 of FIG. 5. The cellular access base station 521 can operate according to common wireless access protocols such as GSM, CDMA, TDMA, UMTS, WiMax, SDR, LTE, and so on. Other present and next generation wireless network technologies can be used by one or more embodiments of the subject disclosure. Accordingly, multiple wireline and wireless communication technologies can be used by the CDs of FIG. 5.

Cellular phones supporting LTE can support packet-switched voice and packet-switched data communications and thus may operate as IMS-compliant mobile devices. In this embodiment, the cellular base station 521 may communicate directly with the IMS network 550 as shown by the arrow connecting the cellular base station 521 and the P-CSCF 516.

It is further understood that alternative forms of a CSCF can operate in a device, system, component, or other form of centralized or distributed hardware and/or software. Indeed, a respective CSCF may be embodied as a respective CSCF system having one or more computers or servers, either centralized or distributed, where each computer or server may be configured to perform or provide, in whole or in part, any method, step, or functionality described herein in accordance with a respective CSCF. Likewise, other functions, servers and computers described herein, including but not limited to, the HSS, the ENUM server, the BGCF, and the MGCF, can be embodied in a respective system having one or more computers or servers, either centralized or distributed, where each computer or server may be configured to perform or provide, in whole or in part, any method, step, or functionality described herein in accordance with a respective function, server, or computer.

Media server 130 can perform function 570 and thereby provide media services to the CDs 501, 502, 503 and 505 of FIG. 5. CDs 501, 502, 503 and 505, which can be adapted with software 572 to perform function 574 to utilize the services of the media server 130. The media server 130 can be an integral part of the application server(s) 517 performing function 570, which can be substantially similar to function 462 and adapted to the operations of the IMS network 550.

For illustration purposes only, the terms S-CSCF, P-CSCF, I-CSCF, and so on, can be server devices, but may be referred to in the subject disclosure without the word “server.” It is also understood that any form of a CSCF server can operate in a device, system, component, or other form of centralized or distributed hardware and software. It is further noted that these terms and other terms such as DIAMETER commands are terms can include features, methodologies, and/or fields that may be described in whole or in part by standards bodies such as Third Generation Partnership Project (3GPP). It is further noted that some or all embodiments of the subject disclosure may in whole or in part modify, supplement, or otherwise supersede final or proposed standards published and promulgated by 3GPP.

FIG. 6 depicts an illustrative embodiment of a web portal 602 which can be hosted by server applications operating from the computing devices 130 of the communication system 400 illustrated in FIG. 4. The communication system 400 can be utilized to provide media content to a wireless media processor device 106 for presentation by a media display device 108. The web portal system 600 can be used to register and maintain subscriber location and contact information and to configure alerts.

The web portal 602 can be used for managing services of communication systems 400-500. A web page of the web portal 602 can be accessed by a Uniform Resource Locator (URL) with an Internet browser such as Microsoft's Internet Explorer™, Mozilla's Firefox™, Apple's Safari™, or Google's Chrome™ using an Internet-capable communication device such as those described in FIGS. 1-2. The web portal 602 can be configured, for example, to access a media processor 106A and services managed thereby such as a Digital Video Recorder (DVR), a Video on Demand (VoD) catalog, an Electronic Programming Guide (EPG), or a personal catalog (such as personal videos, pictures, audio recordings, etc.) stored at the media processor 106A. The web portal 602 can also be used for provisioning IMS services described earlier, provisioning Internet services, provisioning cellular phone services, and so on.

The web portal 602 can further be utilized to manage and provision software applications 462-465, and 570-574 to adapt these applications as may be desired by subscribers and service providers of communication systems 400-500.

FIG. 7 depicts an illustrative embodiment of a communication device 700. Communication device 700 can serve in whole or in part as an illustrative embodiment of the devices depicted or otherwise described in FIGS. 1-6. The communication device 700 can be utilized to receive emergency alert notifications, messages, and/or video streams for display at a wireless media processor device 106; a media display device 108, and/or a mobile communication device 116A.

The communication device 700 can perform an operation associated with the presentation of the emergency alert information at a display according to the first action of the first viewer. The communication device 700 can comprise a wireline and/or wireless transceiver 702 (herein transceiver 702), a user interface (UI) 704, a power supply 714, a location receiver 716, a motion sensor 716, an orientation sensor 720, and a controller 706 for managing operations thereof. The transceiver 702 can support short-range or long-range wireless access technologies such as Bluetooth, ZigBee, Wi-Fi, DECT, or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 702 can also be adapted to support circuit-switched wireline access technologies (such as PSTN), packet-switched wireline access technologies (such as TCP/IP, VoIP, etc.), and combinations thereof.

The UI 704 can include a depressible or touch-sensitive keypad 706 with a navigation mechanism such as a roller ball, a joystick, a mouse, or a navigation disk for manipulating operations of the communication device 700. The keypad 706 can be an integral part of a housing assembly of the communication device 700 or an independent device operably coupled thereto by a tethered wireline interface (such as a USB cable) or a wireless interface supporting for example Bluetooth. The keypad 706 can represent a numeric keypad commonly used by phones, and/or a QWERTY keypad with alphanumeric keys. The UI 704 can further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 706 can be presented by way of the display 710 with navigation features.

The display 710 can use touch screen technology to also serve as a user interface for detecting user input. As a touch screen display, the communication device 700 can be adapted to present a user interface with graphical user interface (GUI) elements that can be selected by a user with a touch of a finger. The touch screen display 710 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 710 can be an integral part of the housing assembly of the communication device 700 or an independent device communicatively coupled thereto by a tethered wireline interface (such as a cable) or a wireless interface.

The UI 704 can also include an audio system 712 that utilizes audio technology for conveying low volume audio (such as audio heard in proximity of a human ear) and high volume audio (such as speakerphone for hands free operation). The audio system 712 can further include a microphone for receiving audible signals of an end user. The audio system 712 can also be used for voice recognition applications. The UI 704 can further include an image sensor 713 such as a charged coupled device (CCD) camera for capturing still or moving images.

The power supply 714 can utilize common power management technologies such as replaceable and rechargeable batteries, supply regulation technologies, and/or charging system technologies for supplying energy to the components of the communication device 700 to facilitate long-range or short-range portable applications. Alternatively, or in combination, the charging system can utilize external power sources such as DC power supplied over a physical interface such as a USB port or other suitable tethering technologies.

The location receiver 716 can utilize location technology such as a global positioning system (GPS) receiver capable of assisted GPS for identifying a location of the communication device 700 based on signals generated by a constellation of GPS satellites, which can be used for facilitating location services such as navigation. The motion sensor 716 can utilize motion sensing technology such as an accelerometer, a gyroscope, or other suitable motion sensing technology to detect motion of the communication device 700 in three-dimensional space. The orientation sensor 720 can utilize orientation sensing technology such as a magnetometer to detect the orientation of the communication device 700 (north, south, west, and east, as well as combined orientations in degrees, minutes, or other suitable orientation metrics).

The communication device 700 can use the transceiver 702 to also determine a proximity to a cellular, Wi-Fi, Bluetooth, or other wireless access points by sensing techniques such as utilizing a received signal strength indicator (RSSI) and/or signal time of arrival (TOA) or time of flight (TOF) measurements. The controller 706 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 400.

Other components not shown in FIG. 7 can be used in one or more embodiments of the subject disclosure. For instance, the communication device 700 can include a reset button (not shown). The reset button can be used to reset the controller 706 of the communication device 700. In yet another embodiment, the communication device 700 can also include a factory default setting button positioned, for example, below a small hole in a housing assembly of the communication device 700 to force the communication device 700 to re-establish factory settings. In this embodiment, a user can use a protruding object such as a pen or paper clip tip to reach into the hole and depress the default setting button. The communication device 400 can also include a slot for adding or removing an identity module such as a Subscriber Identity Module (SIM) card. SIM cards can be used for identifying subscriber services, executing programs, storing subscriber data, and so forth.

The communication device 700 as described herein can operate with more or less of the circuit components shown in FIG. 7. These variant embodiments can be used in one or more embodiments of the subject disclosure.

The communication device 700 can be adapted to perform the functions of the wireless media processor device 106, the media display device 108, and/or the mobile communication devices 116A of FIG. 4, as well as the IMS CDs 501-502 and PSTN CDs 503-505 of FIG. 5. It will be appreciated that the communication device 700 can also represent other devices that can operate in communication systems 400-500 of FIGS. 4-5 such as a gaming console and a media player.

The communication device 700 shown in FIG. 7 or portions thereof can serve as a representation of one or more of the devices of communication systems 600-700. In addition, the controller 706 can be adapted in various embodiments to perform the functions 462-465 and 570-574, respectively.

In one or more embodiments, the wireless set top box can request and obtain remote access to multiple home media processor subscriber accounts where the accounts may or may not be related. In this example, the wireless set top box can present media content or present other communication services (e.g., voice, video and/or data) associated with the multiple subscriber accounts at multiple display devices and/or at the same display device (e.g., multiple windows on a screen or picture-in-picture presentation. In one or more embodiments, the wireless set top box is a multi-mode communication device capable of engaging simultaneously in multiple communication sessions that utilize different wireless protocols.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

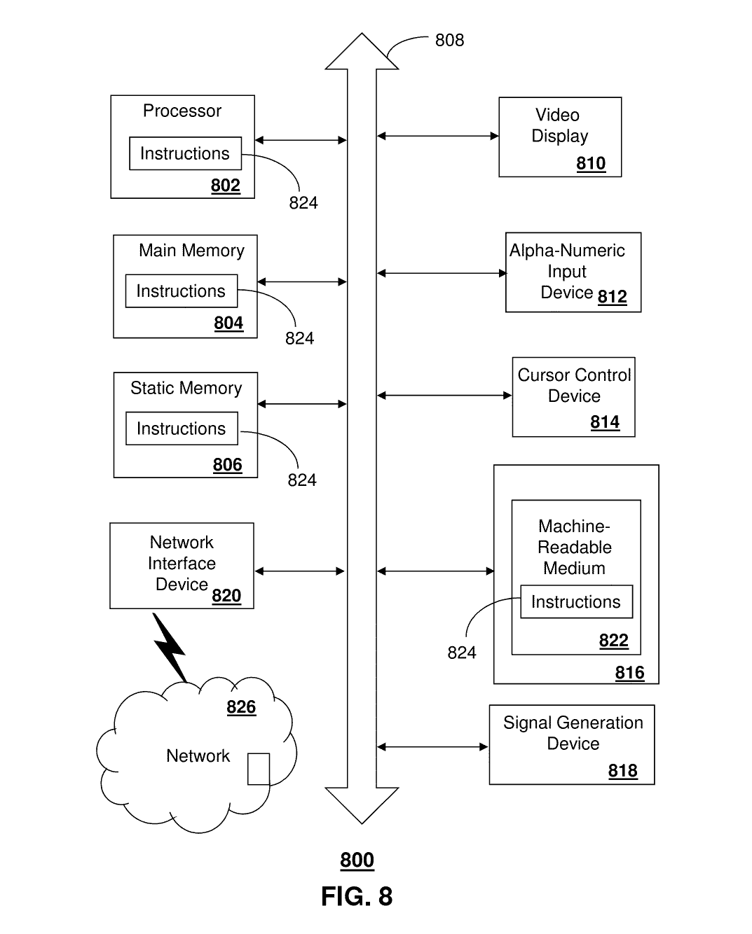

FIG. 8 depicts an exemplary diagrammatic representation of a machine in the form of a computer system 800 within which a set of instructions, when executed, may cause the machine to perform any one or more of the methods describe above. For example, the wireless media processor device 106, the media server device 130, the media display device 108, and/or the gateway device 104, and/or the mobile communication device 116A can comprise a machine in the form of a computer system 800. In some embodiments, the machine may be connected (e.g., using a network 826) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 800 may include a processor (or controller) 802 (e.g., a central processing unit (CPU), a graphics processing unit (GPU, or both), a main memory 804 and a static memory 806, which communicate with each other via a bus 806. The computer system 800 may further include a display unit 810 (e.g., a liquid crystal display (LCD), a flat panel, or a solid state display. The computer system 800 may include an input device 812 (e.g., a keyboard), a cursor control device 814 (e.g., a mouse), a disk drive unit 816, a signal generation device 816 (e.g., a speaker or remote control) and a network interface device 820. In distributed environments, the embodiments described in the subject disclosure can be adapted to utilize multiple display units 810 controlled by two or more computer systems 800. In this configuration, presentations described by the subject disclosure may in part be shown in a first of the display units 810, while the remaining portion is presented in a second of the display units 810.

The disk drive unit 816 may include a tangible computer-readable storage medium 822 on which is stored one or more sets of instructions (e.g., software 824) embodying any one or more of the methods or functions described herein, including those methods illustrated above. The instructions 824 may also reside, completely or at least partially, within the main memory 804, the static memory 806, and/or within the processor 802 during execution thereof by the computer system 800. The main memory 804 and the processor 802 also may constitute tangible computer-readable storage media.

Dedicated hardware implementations including, but not limited to, application specific integrated circuits, programmable logic arrays and other hardware devices that can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable array. Furthermore, software implementations (e.g., software programs, instructions, etc.) can include, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 822 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, Wi-Fi, Zigbee), and long-range communications (e.g., WiMAX, GSM, CDMA, LTE) can be used by computer system 800.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure, including combinations of components and/or steps from the embodiments and/or methods described herein.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device, comprising:
a memory to store computer instructions; and
a processor coupled to the memory, wherein the processor, responsive to executing the computer instructions, performs operations comprising:
detecting a mobile wireless network;
transmitting a first request for remote access to a home media processor subscriber account via the mobile wireless network;
receiving authentication for the remote access to the home media processor subscriber account responsive to the first request;
transmitting a second request for home media processor information from the mobile wireless network;
receiving the home media processor information from the mobile wireless network responsive to the second request;
selecting media content according to the home media processor information;
receiving the media content that is selected from the mobile wireless network;
decoding the media content that is received to generate a video stream; and
transmitting the video stream to a display device.

2. The device of claim 1, wherein the operations further comprise:
receiving a third request for subscriber authentication from the mobile wireless network; and
transmitting authenticating information to the mobile wireless network responsive to receiving the third request for subscriber authentication.

3. The device of claim 1, wherein the home media processor information comprises a listing of media services accessible to a home media processor.

4. The device of claim 1, wherein the home media processor information comprises a listing of media content stored at a home media processor.

5. The device of claim 1, wherein the home media processor information comprises a listing of media content previously viewed at a home media processor.

6. The device of claim 1, further performing operations comprising:
accessing an electronic programming guide according to the home media processor information; and
selecting a media program from the electronic programming guide, wherein the media content is associated with the media program.

7. The device of claim 1, wherein the operations further comprise establishing wireless communications with the display device.

8. The device of claim 1, wherein the operations further comprise accessing a listing of recorded media content at a digital video recorder of a home media processor, wherein the media content is selected from the listing.

9. The device of claim 1, wherein the operations further comprise:
determining a configuration of the display device;
transcoding the video stream according to the configuration of the display device to generate a transcoded video stream; and
transmitting the transcoded video stream to the display device.

10. The device of claim 9, wherein the transcoding reduces data usage of the mobile wireless network.

11. The device of claim 1, wherein the operations further comprise determining if the media content is accessible over a local wireless link, wherein the media content is received over the local wireless link.

12. The device of claim 1, wherein operations further comprise establishing a high-definition multimedia interface communications link with the display device.

13. A tangible computer-readable storage medium, comprising computer instructions, which, responsive to being executed by a processor, cause the processor to perform operations comprising:
transmitting a first request for remote access by a mobile media processor to a home media processor subscriber account via a mobile wireless network;
receiving authentication for the remote access to the home media processor subscriber account responsive to the first request;
transmitting a second request for home media processor information from the mobile wireless network;
establishing wireless communications to a display device;
selecting media content according to the home media processor information;
receiving from the mobile wireless network the media content that is selected; and
transmitting a video stream of the media content for presentation at the display device.

14. The tangible computer-readable storage medium of claim 13, wherein the home media processor information comprises a listing of media services accessible to a home media processor, media content stored at the home media processor, and media content previously viewed at the home media processor.

15. The tangible computer-readable storage medium of claim 14, wherein the operations further comprise:
determining a configuration of the display device;
transcoding the video stream according to the configuration of the display device to generate a transcoded video stream; and
transmitting the transcoded video stream to the display device.

16. The tangible computer-readable storage medium of claim 14, wherein the operations further comprise:
accessing an electronic programming guide according to the home media processor information; and
selecting a media program from the electronic programming guide, wherein the media content is associated with the media program.

17. A method, comprising:
establishing, by a system comprising a processor, communication with a mobile wireless network to access a home media processor subscriber account via the mobile wireless network;
receiving, by the system, media content from the mobile wireless network based on home media processor information from the home media processor subscriber account; and
transmitting, by the system, to a display device a video stream generated based on the media content.

18. The method of claim 17, wherein the home media processor information comprises a listing of media services accessible to the home media processor, media content stored at the home media processor, and media content previously viewed at the home media processor.

19. The method of claim 17, comprising:
determining, by the system, a configuration of the display device;
transcoding, by the system, the video stream according to the configuration of the display device to generate a transcoded video stream; and
transmitting, by the system, the transcoded video stream to the display device.

20. The method of claim 17, comprising:
accessing, by the system, an electronic programming guide according to the home media processor information; and
selecting, by the system, a media program from the electronic programming guide, wherein the media content is associated with the media program.
